(19) United States
(12) Patent Application Publication
(10) Pub. No.: US 2010/0307247 A1
(43) Pub. Date: Dec. 9, 2010

(54) MICROMECHANICAL ACCELERATION SENSOR AND METHOD FOR MANUFACTURING AN ACCELERATION SENSOR

(76) Inventor: Heribert Weber, Nuertingen (DE)

Correspondence Address: KENYON & KENYON LLP, ONE BROADWAY, NEW YORK, NY, 10004, US

(21) Appl. No.: 12/793,179

(22) Filed: Jun. 3, 2010

(30) Foreign Application Priority Data
Jun. 4, 2009 (DE) 102009026738.7

(51) Int. Cl. G01P 15/10; B23P 17/04

(52) U.S. Cl. 73/514.29; 29/428

(57) ABSTRACT

A micromechanical acceleration sensor for a transport device, in particular a motor vehicle, having a seismic mass. The seismic mass includes an auxiliary mass, and the auxiliary mass is composed of a different material than the seismic mass. Also described is a method for manufacturing an acceleration sensor for a transport device, in particular a motor vehicle, having a seismic mass, an auxiliary mass being provided on/in the seismic mass when forming the seismic mass. Also described is an assembly, apparatus, or device, in particular for a motor vehicle. The assembly, apparatus, or device has a micromechanical acceleration sensor as described, or an acceleration sensor manufactured as described.

### CROSS REFERENCE

The present application claims the benefit under 35 U.S.C. §119 of German Patent Application No. 102009026738.7 filed on Jun. 4, 2009, which is expressly incorporated herein by reference in its entirety.

### FIELD OF THE INVENTION

The present invention relates to a micromechanical acceleration sensor, having a seismic mass, for, e.g., a motor vehicle. The present invention further relates to a method for manufacturing an acceleration sensor.

### BACKGROUND INFORMATION

Micromechanical acceleration sensors are often designed as mass-spring systems having capacitive evaluation of the deflections of a seismic mass caused by mechanical forces or torques that are present. For this purpose, at least one electrode pair is provided in the acceleration sensor which generally forms a plate capacitor whose capacitance is a function of the deflection of the seismic mass. It is also known to design multiaxial acceleration sensors with a single seismic mass, which may be used for measuring accelerations in multiple directions in combination with a central suspension of the seismic mass.

In the latter case, a seismic mass movably supported, for example, outside its center of gravity is provided for an acceleration sensor, and inside the acceleration sensor an electrode is provided on the seismic mass, and at a distance therefrom within the acceleration sensor, electrodes are provided outside the seismic mass, in each case forming a capacitive sensor in order to detect a change in the position of the seismic mass as a function of time in more than one spatial direction. For the acceleration sensor, at least one spring device is provided on a side of the seismic mass facing a capacitive sensor, the spring device producing a restoring force when the seismic mass is deflected from its neutral position.

### SUMMARY

An object of the present invention is to provide an improved micromechanical acceleration sensor and a manufacturing method for an acceleration sensor. The aim is to improve the sensitivity, response characteristic, and/or sensing accuracy of the acceleration sensor compared to the related art. Only a very slight change to the design of a conventional acceleration sensor should be necessary, and the acceleration sensor should be manufacturable using only a slightly modified production process. This should also apply for acceleration sensors which are able to sense accelerations in more than one spatial direction. A further aim is to allow the acceleration sensor to be used in a compact and easily manufacturable housing.

According to the present invention, a micromechanical acceleration sensor is provided for a transportation device, e.g., a motor vehicle. A method for manufacturing an acceleration sensor for the transportation device, e.g., a motor vehicle, is also provided. An assembly, apparatus, or device having a micromechanical acceleration sensor according to the present invention or an acceleration sensor manufactured according to the present invention are also provided.

The example acceleration sensor according to the present invention includes a seismic mass supported by suspension within the acceleration sensor. The seismic mass has an additional material layer, a so-called “auxiliary mass,” the additional material layer being composed of a different material than the seismic mass or the material layer thereof. The material layer of the auxiliary mass preferably has a greater density than the material layer of the seismic mass. According to an example embodiment of the present invention, for forming the material layer of the seismic mass the additional material layer is provided on/in the acceleration sensor. The example acceleration sensor according to the present invention may be a capacitive, inductive, and/or piezoelectric acceleration sensor, for example, which is not limited to the automotive sector.

The material layer of the seismic mass may be provided before or after the material layer of the auxiliary mass is formed, the former approach being preferred. It is also possible to interrupt formation of the material layer of the seismic mass, to provide the, or a, material layer of the auxiliary mass, and then to resume formation of a material layer of the seismic mass. This may also be carried out multiple times in succession. As a result, at least one auxiliary mass is formed, at least partially within the seismic mass.

In specific embodiments of the present invention, a single suspension or multiple suspensions of the seismic mass is/are in particular spring devices, in each case preferably formed from a diaphragm provided or formed on the seismic mass and a support for the seismic mass or the diaphragm. The support is, for example, a base, peg, or fastening element on the seismic mass, in particular on the diaphragm of the seismic mass. According to the present invention, the, or a, spring device may also be provided on the auxiliary mass, which then adjoins the seismic mass.

In specific embodiments of the present invention the material layer of the auxiliary mass contains tungsten, gold, platinum, or iridium, while the material layer of the seismic mass preferably contains silicon. According to the example embodiment of the present invention the material layer of the auxiliary mass may be made of the same material as that for an electrical contact for the acceleration sensor, for example bond pads. The electrical contact and the material layer of the auxiliary mass may be formed simultaneously or at least partially sequentially, depending on an intended layer thickness of the electrical contact or an intended layer thickness of the material layer of the auxiliary mass.

The material layer of the auxiliary mass may be provided on/in the seismic mass facing away from a support, in particular a spring device, of the seismic mass in the acceleration sensor. The material layer of the auxiliary mass may be provided on/in the seismic mass symmetrically or asymmetrically with respect to the seismic mass, and/or symmetrically or asymmetrically with respect to a center of gravity of the seismic mass. The material layer of the auxiliary mass may be provided completely or partially in a depression in the seismic mass. An electrical insulation layer may also be provided between the material layer of the auxiliary mass and the material layer of the seismic mass.

As the result of placing a material which is heavier than the material of the seismic mass on the seismic mass according to the present invention, a center of gravity of the seismic mass is situated farther from a fastening or support point of the seismic mass, and thus for otherwise unchanged geometric factors a smaller acceleration or force is necessary for a corresponding signal. This is equivalent to increased sensitivity, a better response characteristic, and increased sensing accuracy of the acceleration sensor. In addition, by use of the present invention a conventional acceleration sensor needs to be only slightly modified, and has a compact design.

### BRIEF DESCRIPTION OF THE DRAWINGS

The present invention is explained in greater detail below based on exemplary embodiments, with reference to the accompanying figures.

FIGS. 1-5 show in respective sectional views a number of manufacturing steps in a first specific example embodiment of an acceleration sensor according to the present invention.

FIG. 6 shows in a sectional view a second specific example embodiment of the acceleration sensor according to the present invention.

FIG. 7 likewise shows in a sectional view a third specific example embodiment of the acceleration sensor according to the present invention.

### DETAILED DESCRIPTION OF EXAMPLE EMBODIMENTS

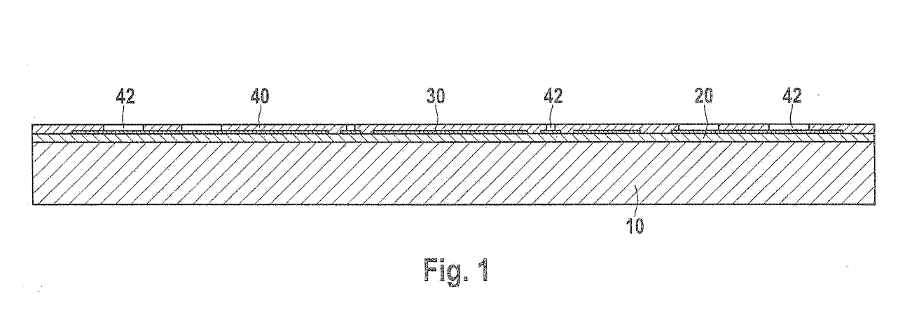

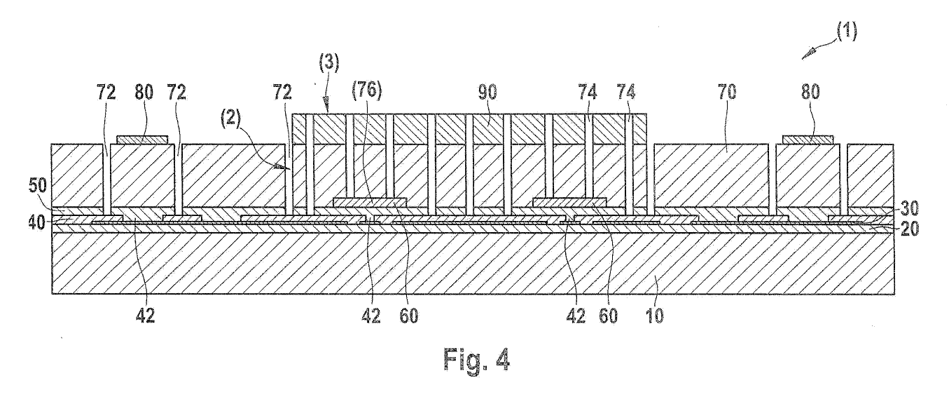

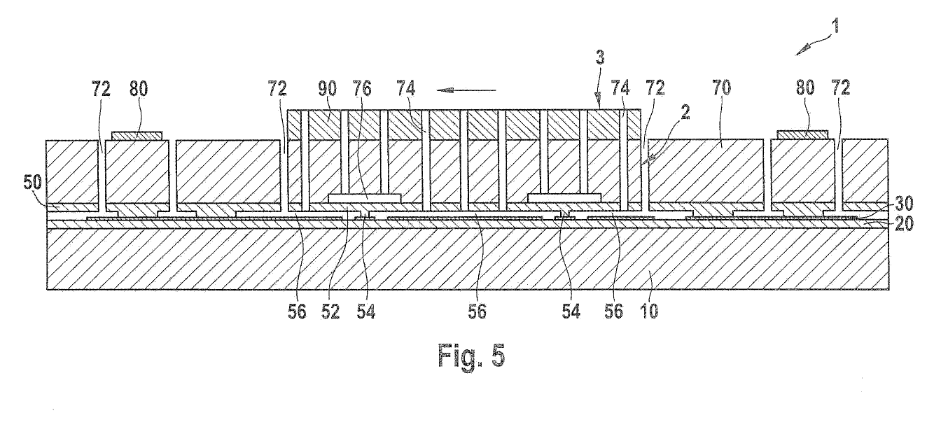

FIG. 1 shows the first manufacturing steps for a micromechanical acceleration sensor 1 according to an example embodiment of the present invention (see FIGS. 5-7). First a substrate 10, in particular a silicon wafer 10, is provided with an insulation layer 20, upon which printed conductors 30 are deposited. Insulation layer 20 may be composed of silicon oxide, silicon nitride, or silicon oxynitride, for example. Various methods are available for depositing insulation layer 20. For example, the silicon substrate may be brought to an elevated temperature in an oxygen atmosphere in order to oxidize its surface. Printed conductors 30 are composed of an electrically conductive material, for example a metal, metal alloy, or conductively doped silicon, and may be deposited using LPCVD or PECVD methods, epitaxial growth, vapor deposition, or sputtering. Printed conductors 30 have a specific structure, which allows finished acceleration sensor 1 to be electrically contacted. A sacrificial layer 40 composed of silicon dioxide, for example, is then applied, which may be etched using a gas phase etching process, for example. Contact recesses 42 at which printed conductors 30 or metal plating 30 are exposed are introduced into this sacrificial layer 40. Sacrificial layer 40 is also used as a stop layer for trenches 72, 74 to be subsequently produced (see FIGS. 4-7).

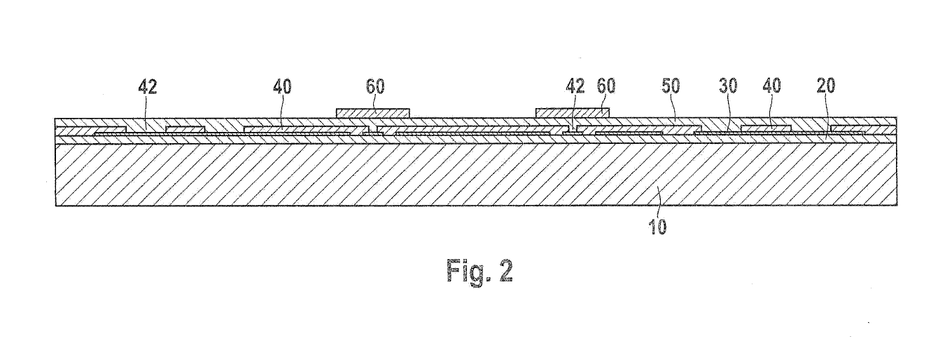

The next two method steps are illustrated in FIG. 2. A first layer 50, in particular a silicon layer 50, is deposited on substrate 10, 20, 30, 40 from FIG. 1. This silicon layer 50 later forms an exterior of a movably supported seismic mass 2 and a diaphragm 52 on a cavity 76 formed inside seismic mass 2 (see FIGS. 5-7). A thickness of silicon layer 50 also defines a spring constant of spring devices 52, 54 (see FIGS. 5-7) on which seismic mass 2 is supported. Since seismic mass 2 is preferably used as a counterelectrode for capacitive sensors within acceleration sensor 1, silicon layer 50 may already be doped. This allows seismic mass 2 to be electrically contacted in a particularly simple manner. A stop layer 60, in particular an etch stop layer 60, composed of silicon dioxide, for example, is deposited on silicon layer 50 and covers the entire surface of substrate 10 having insulation layer 20, printed conductors 30, and sacrificial layer 40. This etch stop layer 60 is used in a further procedure as a sacrificial layer 60 for forming cavity or cavities 76 in seismic mass 2, and at the same time is used as a stop layer 60 for trenches 72, 74 to be subsequently produced. Etch stop layer 60 is structured by plasma etching or wet chemical etching, for example, in such a way that silicon dioxide is present only in the surface regions in which spring devices 52, 54 of seismic mass 2 are to be subsequently provided.

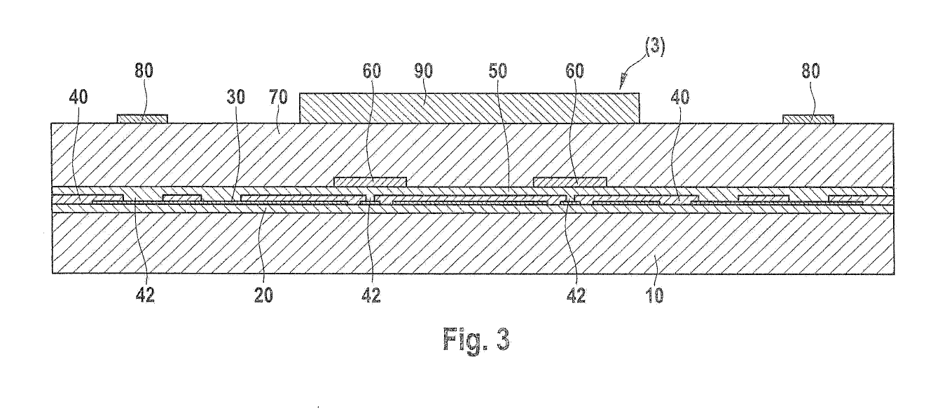

According to FIG. 3, a second layer 70, in particular a silicon layer 70, is deposited on substrate 10, 20, 30, 40, 50, 60 from FIG. 2. This silicon layer 70 is advantageously conductively doped. Of course, silicon layer 70 may be deposited undoped as intrinsic silicon material. In this case it is necessary to dope only the regions of silicon layer 70 in which electrical conductivity is required for operation of acceleration sensor 1. Layers 50, 70 preferably form a homogeneous layer together with incorporated oxide layer 60. Layers 50, 70 should be regarded as homogeneous when a boundary surface between same is not detectable with a reasonable expenditure of effort. Electrical contacts 80 are applied to silicon layer 70 which is deposited over the entire surface. These electrical contacts are located at defined points at which acceleration sensor 1 is subsequently connected to an external electronic circuit. Such a metal plating 80 may be provided, for example, as a bond pad 80 made of a metal or an alloy. Alternatively, acceleration sensor 1 may be contacted via conductively doped polysilicon layers 80. Conventional layers or layer sequences and manufacturing methods are preferably used for producing contacts 80.

An auxiliary mass layer 90 is provided on a free surface of second layer 70, in a region above stop layer 60 (see FIGS. 3-7), which is possible using customary methods, for example (see below). When seismic mass 2 is exposed (see FIGS. 5-7), auxiliary mass layer 90 subsequently forms an auxiliary mass 3 for seismic mass 2; i.e., according to the example embodiment of the present invention a movable mass 2, 3 of acceleration sensor 1 includes seismic mass 2 and auxiliary mass 3 thereof. Auxiliary mass layer 90 or auxiliary mass 3 preferably has a density several times that of second layer 70. Materials which may be used for this purpose include gold, platinum, iridium, or tungsten, for example. Of course, other materials may also be used. Tungsten, for example, has the advantage that plugs made of this material are already used for electrical feedthroughs in semiconductor microelectronics, so that the material is compatible with semiconductors and may also be structured with the aid of plasma etching processes using sulfur hexafluoride. This results in simplified process control, since by use of such a plasma etching step the tungsten may be etched on silicon layer 70 in the region of resulting seismic mass 2, and also the silicon therebelow may be etched in the same facility, using the same etching mask.

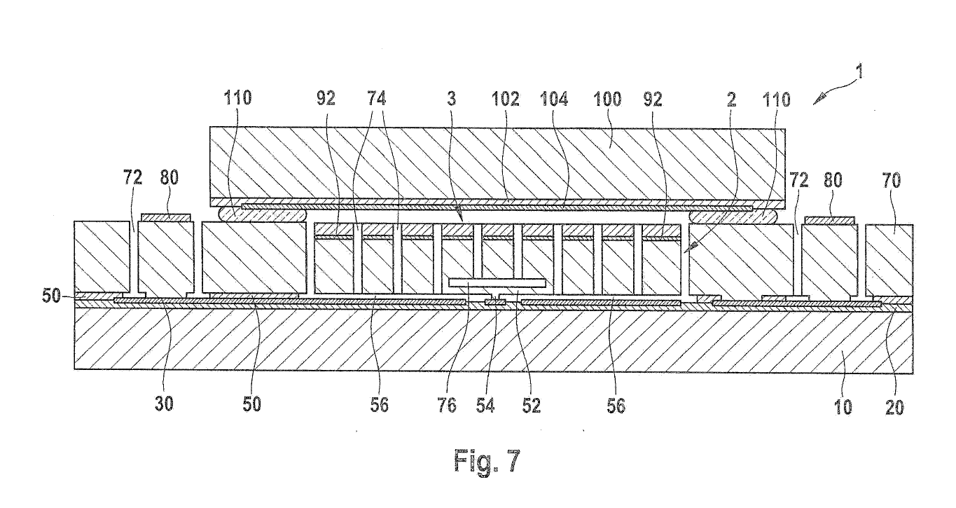

Denser auxiliary mass layer 90 may be deposited on a top side of seismic mass 2, either directly on silicon layer 70 (see FIGS. 3-6) or separated therefrom by an electrical insulation layer 92 (see FIG. 7). The latter is particularly advantageous when the material of auxiliary mass layer 90 is simultaneously used for implementing an electrical wiring level, a bond frame, or electrical contacts 80 outside a region of seismic mass 2 (not illustrated in the drawing). The material of auxiliary mass layer 90 may also be deposited in a depression provided beforehand in the surface of silicon layer 70, or may be provided only partially embedded at the surface of seismic mass 2 (not illustrated in the drawing). With the aid of conventional planarization methods it is also possible to planarize a resulting surface in such a way that a low-topography surface is obtained. In this manner additional levels may be produced (see FIG. 7) using standard semiconductor processes such as spin coating, for example. A spray coating may be used if planarization is omitted. Auxiliary mass layer 90 may cover the entire surface of seismic mass 2 (see FIGS. 5-7). It is also possible to only partially cover seismic mass 2 with auxiliary mass layer 90, i.e., to not provide auxiliary mass layer 90 centrally on seismic mass 2, or to provide a full-surface or partial-surface auxiliary mass layer 90 within seismic mass 2 (not illustrated in the drawing).

FIG. 4 shows the cross section from FIG. 3 after multiple etching channels 72, 74, i.e., trenches 72, 74, have been etched into auxiliary mass layer 90 and silicon layer 70. These trenches 72, 74 include oblong trenches 72 which extend along an external boundary surface of seismic mass 2 and/or which expose electrical contacts 80 from the surrounding silicon material. Adjacent thereto, further trenches 74 are present within the not yet fully exposed seismic mass 2 which pass through auxiliary mass layer 90 and silicon layer 70, and which may also have an oblong or a differently shaped cross section. The shape and position of trenches 72, 74 is determined by a mask. If all trenches 72, 74 are etched in one method step, a single etching mask is sufficient. Etched trenches 72, 74 are preferably produced by chemically selective etching, so that in each case the etched trenches end on a silicon dioxide layer situated therebeneath, either on sacrificial layer 60 or sacrificial layer 50. As shown in FIG. 5, sacrificial layers 50, 60 are removed through trenches 72, 74. This is carried out, for example, by gas phase etching using gaseous hydrofluoric acid. Removal of sacrificial layer 50 beneath seismic mass 2 results in a cavity 56 between seismic mass 2 and printed conductors 30. Pillar-shaped supports 54 made of silicon, which originally were deposited in contact recesses 42, remain within cavity 56. Removal of sacrificial layer 60 results in cavity 76 within seismic mass 2 which is closed off by diaphragm 52, which in turn results from cutting off first layer 50. Thus, trenches 72 and cavity 56 result in freestanding seismic mass 2 which is supported by spring devices 52, 54. A spring device 52, 54 is composed of a support 54 and a diaphragm 52.

If seismic mass 2 and first silicon layer 50 are made of conductively doped silicon, seismic mass 2 may be connected to a printed conductor 30 via spring devices 52, 54. Seismic mass 2 may thus be used as a shared counterelectrode for all capacitive distance sensors of acceleration sensor 1. To measure an acceleration which acts generally vertically with respect to the surface of acceleration sensor 1 (with reference to FIGS. 5-7), an electrode which has been exposed from metal plating 30 is situated beneath seismic mass 2 on an oppositely situated side of cavity 56. The distance of seismic mass 2 from metal plating 30 may thus be measured capacitively with high accuracy. An acceleration which acts on seismic mass 2 parallel to the surface of acceleration sensor 1 results in tilting of seismic mass 2. If, for example, an acceleration force acts to the left (see arrow in FIG. 5), trench 72 to the right of seismic mass 2 is wider, and trench 72 to the left of seismic mass 2 is narrower. Likewise, cavity 56 is smaller on one side of seismic mass 2 and is larger on the other side. This change may be measured with the aid of appropriately positioned electrodes. Likewise, an acceleration may be measured in a direction rotated by 90° in the horizontal.

Acceleration sensor 1 illustrated in FIG. 5 and manufactured according to the present invention has a decentralized suspension of seismic mass 2, at least two spring devices 52, 54 being symmetrically distributed about a center of seismic mass 2. Of course, more than two spring devices 52, 54 may be provided. In addition, diaphragm 52 may be perforated, which reduces the etching time when sacrificial layer 40 is removed beneath spring devices 52, 54. Depending on the perforation, this results in an additional possibility for setting a spring stiffness and spring characteristic.

It is also possible after depositing second layer 70 (transition from FIG. 2 to FIG. 3) to first apply and structure a bond pad metal plating 80 (electrical contact 80), for example an alloy of aluminum and copper or of aluminum, silicon, and copper, on second layer 70. Bond pad metal plating 80 may then be covered with a passivation layer made of silicon dioxide, for example, the passivation layer being further structured. As a result, auxiliary mass 3 is then applied by sputtering and structuring, for example. It may be important to ensure that in the deposition process for the passivation layer and auxiliary mass layer 90, or in a subsequent temperature equilibration step, a process temperature is selected in such a way that favorable electrical contact resistance is provided between bond pad metal plating 80 and second layer 70. Bond pad metal plating 80 may optionally remain, at least partially, beneath auxiliary mass 3. For this purpose the passivation layer is deposited and structured before bond pad metal plating 80. In addition, bond pad metal plating 80 may be deposited and structured only after auxiliary mass 3 has been structured. In this case, bond pad metal plating 80 may also optionally remain on auxiliary mass 3. In these specific example embodiments it is advantageous that the material of bond pads 80 and the material of auxiliary mass 3 may be different, which in turn may be advantageous for subsequent wire bonding.

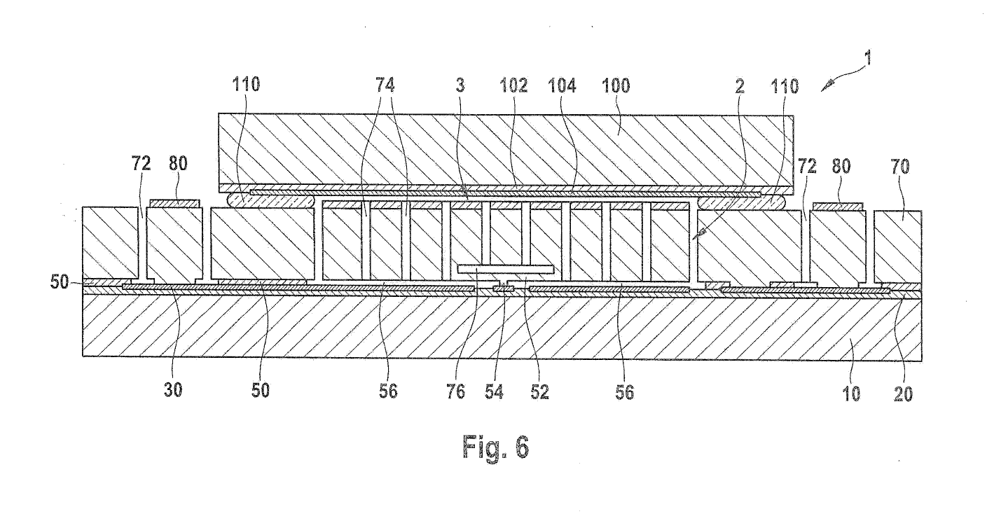

FIGS. 6 and 7 show alternative specific example embodiments of acceleration sensor 1 according to the present invention. The specific example embodiments differ from that according to FIG. 5, for example, in that the region around seismic mass 2 is enclosed by a cap 100 or cover 100. This reliably prevents casting compound from penetrating into a housing during installation of acceleration sensor 1. If cap 100 hermetically seals a cavity together with seismic mass 2, an internal pressure may be set in this cavity. Thus, for example, damping of the motion of seismic mass 2 may be reduced as the result of a lowered internal pressure. In addition, in contrast to the specific embodiment according to FIG. 5, these specific example embodiments have a central suspension of seismic mass 2, which increases the sensitivity of acceleration sensor 1 in all three spatial directions.

An electrically conductive layer 104, for example a metal plating 104, may also be provided on cap 100. If such a layer 104 is to be separated from an electrically conductive cap 100, an insulation layer 102 may be provided therebetween. In this manner cap 100 may be used as a shield, and electrically conductive layer 104 may be used as a measuring electrode. This metal plating 104 acts as an electrode, and together with seismic mass 2, which is preferably likewise electrically conductive, capacitively determines a distance of seismic mass 2 from cap 100. The reliability of acceleration sensor 1 may thus be increased. By subdividing metal plating 104 and electrically contacting the partial surfaces, tilting of seismic mass 2 resulting from an acceleration acting parallel to the surface of acceleration sensor 1 may also be evaluated in a differential capacitive manner. Cap 100 may be affixed to silicon layer 70 using a fastening element 110 which is electrically insulating, for example Sealglas, or electrically conductive. In the latter case, metal plating 104 is electrically contacted via electrically conductive fastening element 110, silicon layer 70, and metal plating 30. In a further specific example embodiment the electrical contact of metal plating 104 may also be situated inside the hermetically sealed housing region.

FIGS. 6 and 7 also show alternative specific example embodiments of auxiliary mass 3. FIG. 6 shows a comparatively thin auxiliary mass 3 which rests directly on the silicon of seismic mass 2. In principle, a thicker auxiliary mass layer 90 may be used when, for example, a suitable cavern (not illustrated in the drawing) is provided in cap 100. In contrast, in FIG. 7 auxiliary mass 3 is thicker, and is separated from the silicon of seismic mass 2 via insulation layer 92. A layer thickness of auxiliary mass layer 90 is preferably 1% to 50%, in particular 2% to 5%, particularly preferably 6% to 10%, and very particularly preferably 20% to 30% of an overall height of seismic mass 2, including auxiliary mass 3. A mass of auxiliary mass 3 is preferably 0.5 to 10 times, in particular 1 to 2 times, particularly preferably 3 to 4 times, and very particularly preferably 5 to 7 times a mass of seismic mass 2. FIGS. 6 and 7 also show alternative designs of spring devices 52, 54 in cross section. Other spring devices, a two-stage spring structure, for example (not illustrated in the drawing), may of course be used. In addition, stop structures may be provided which prevent a hard impact of seismic mass 2 if an excessively large acceleration force acts on acceleration sensor 1 (not illustrated in the drawing). Such acceleration sensors 1 are used in motor vehicles, for example, to trigger safety devices, or in portable devices to detect impact stress, for example as the result of falling.

What is claimed is:

1. A micromechanical acceleration sensor, comprising:
a seismic mass for a motor vehicle, the seismic mass including an auxiliary mass, the auxiliary mass being composed of a different material than the seismic mass.

2. A method for manufacturing an acceleration sensor, having a seismic mass, for a motor vehicle, comprising:
forming the seismic mass, and
providing an auxiliary mass one of on or in the seismic mass.

3. The method as recited in claim 2, wherein the auxiliary mass is provided one of before or after the seismic mass is formed.

4. The acceleration sensor as recited in claim 1, wherein a material of the auxiliary mass has a greater density than a material of the seismic mass, and the material of the auxiliary mass contains one of tungsten, gold, platinum, or iridium.

5. The acceleration sensor as recited in claim 1, wherein a material of the auxiliary mass is the same as a material of an electrical contact of the acceleration sensor, the electrical contact being a bond pad.

6. The acceleration sensor as recited in claim 1, wherein the auxiliary mass is provided one of on or in the seismic mass facing away from a support of the seismic mass in the acceleration sensor.

7. The acceleration sensor as recited in claim 1, wherein the auxiliary mass is provided one of on or in the seismic mass, and being provided one of symmetrically with respect to the seismic mass or symmetrically with respect to a center of gravity of the seismic mass.

8. The acceleration sensor as recited in claim 1, wherein the auxiliary mass is provided one of on or in the seismic mass, and being provided one of asymmetrically with respect to the seismic mass or asymmetrically with respect to a center of gravity of the seismic mass.

9. The acceleration sensor as recited in claim 1, wherein the auxiliary mass is provided, at least partially, in a depression in the seismic mass.

10. The acceleration sensor as recited in claim 1, further comprising:
an electrical insulation layer arranged between the seismic mass and the auxiliary mass.

11. An assembly for a motor vehicle, the assembly including a micromechanical acceleration sensor, the micromechanical accelerator comprising:
a seismic mass for a motor vehicle, the seismic mass including an auxiliary mass, the auxiliary mass being composed of a different material than the seismic mass.
